(19) United States
(12) Patent Application Publication
(10) Pub. No.: US 2022/0164881 A1
(43) Pub. Date: May 26, 2022

(54) Fractional Share System for Privately Held Companies

(71) Applicant: Emcee Invest, Inc., Brooklyn, NY (US)

(72) Inventors: Arash Asady, Brooklyn, NY (US); Ryan Gary, New York, NY (US)

(21) Appl. No.: 17/532,566

(22) Filed: Nov. 22, 2021

Related U.S. Application Data
(60) Provisional application No. 63/117,253, filed on Nov. 23, 2020.

(51) Int. Cl. G06Q 40/04; G06Q 30/02

(52) U.S. Cl. CPC G06Q 40/04; G06Q 30/0201

(57) ABSTRACT

A method includes receiving data indicating a trigger event corresponding to a user interaction with a particular entity through a platform of the particular entity, wherein the trigger event triggers allocation of shares in the particular entity to a user of a user device, determining a number of reward points issued by the particular entity to be received from the user and an amount of shares of the particular entity to be issued to the user, generating a voucher that authorizes allocation of the amount of shares, transmitting, to the user device, the voucher, and allocating, in response to receiving a payload specifying (i) a voucher identifier matching the voucher and (ii) an entity identifier matching the particular entity from the user device of the user, the amount of shares in the particular entity to the user.

### CROSS-REFERENCE TO RELATED APPLICATIONS

This application claims priority to U.S. Provisional Application Ser. No. 63/117,253 filed on Nov. 23, 2020, the disclosure of which is incorporated in its entirety into this application.

### BACKGROUND

This document relates to data processing and a share management system for privately held companies that are not traded on open exchanges. Generally, shares of a privately held company are obtained through direct interactions between an investor and the privately held company since these shares are not available through open market exchanges, so there is a lack of technological tools for making these shares more widely available.

### SUMMARY

Particular embodiments of the subject matter described in this document can be implemented so as to realize one or more of the following advantages. Systems disclosed herein, which create fractional shares of stock for privately held companies, allow people to have ownership in corporate entities in which they would not otherwise be able to invest. By offering rewards of fractions of shares, the proposed technique engenders brand loyalty and incentivizes users to become interested in the future of the corporate entity in which they have a stake. The proposed technique offers flexibility and ease of access to users—once a user links their account to the system described herein, rewards or other currency issued by a company can be automatically converted to shares through an interface in either the share management system or the company's application. Many systems that offer shares of publicly traded corporate entities as rewards require the user to have a threshold aggregate amount of rewards, such that the user can purchase a full share of stock, prior to providing the reward to the user. The proposed technique provides wider access to shares of privately held companies that are not traded on an open exchange, and therefore not generally available to the public, and also does not force users to wait until they have accumulated sufficient rewards to purchase an entire share. Instead, the system discussed herein allocates fractional shares upon detecting a qualifying trigger event even if the user does not have an aggregate amount of rewards sufficient to purchase a full share of stock in the privately held company. The fractional nature of the system improves user experience by transforming a full share of stock in a privately held company into a partial share of stock in the private company, such that the user is provided an ownership stake without having to accumulate enough rewards to obtain the full share of stock. This also improves goodwill of users toward the system itself and associated corporate entities.

One aspect of the subject matter described herein include a method includes: obtaining, by one or more processors, an allocation of shares in a privately held company that is not listed on a public stock exchange; transforming, by the one or more processors, at least a portion of the allocated shares into fractional shares that represent only a portion of the ownership provided by a single full share of the privately held company; detecting, by one or more processors, a trigger event corresponding to a user interaction with a particular entity through a platform of the particular entity separate from the one or more processors, wherein the trigger event triggers allocation of shares in the particular entity by the one or more processors to a user of a user device; determining, by the one or more processors and based on the detected trigger event, an amount of the fractional shares of the privately held company to be issued to the user; generating, by the one or more processors and based on the number of reward points and the amount of shares, a voucher that authorizes allocation of the amount of fractional shares; transmitting, by the one or more processors and to the user device, the voucher; and allocating, in response to receiving a payload specifying (i) a voucher identifier matching the voucher and (ii) an entity identifier matching the particular entity from the user device of the user, the amount of fractional shares in the privately held company to the user.

In some implementations, the trigger event includes receiving data indicating that the user selected at least one of a number of points issued by the particular entity to be received from the user and the amount of shares of the particular entity.

In some implementations, detecting the trigger event can include receiving data indicating that the user performed a particular user interaction other than a financial transaction.

In some implementations, the trigger event is participation in a program specified by the privately held company.

In some implementations, transmitting, by the one or more processors and to the user device, the voucher includes: transmitting, to a deep link system, the voucher; receiving, from the deep link system, a deep link that includes a payload that specifies the voucher identifier and the entity identifier; and transmitting the deep link to the user device.

In some implantations, methods can include: determining that the privately held company has mapped the particular user interaction to a particular fractional share factor; determining a performance level corresponding to an amount of the particular user interaction performed by the user, wherein determining a fractional number of shares of the particular entity to obtain through the market transaction on behalf of the user comprises determining the fractional number of shares based on a mathematical operation applied to the fractional share factor and the performance level.

In some implantations, methods can include: updating, in response to allocating the amount of shares in the particular entity to the user and by the one or more processors, a record of the voucher; and providing, by the one or more processors, data specifying (i) a debit for the amount of shares against a pool of available shares of the particular entity and (ii) a credit for the amount of shares to the user.

Another aspect of the subject matter described herein includes a system including one or more hardware processors configured to perform operations comprising: obtaining, by one or more processors, an allocation of shares in a privately held company that is not listed on a public stock exchange; transforming, by the one or more processors, at least a portion of the allocated shares into fractional shares that represent only a portion of the ownership provided by a single full share of the privately held company; detecting, by one or more processors, a trigger event corresponding to a user interaction with a particular entity through a platform of the particular entity separate from the one or more processors, wherein the trigger event triggers allocation of shares in the particular entity by the one or more processors to a user of a user device; determining, by the one or more processors and based on the detected trigger event, an amount of the fractional shares of the privately held company to be issued to the user; generating, by the one or more processors and based on the number of reward points and the amount of shares, a voucher that authorizes allocation of the amount of fractional shares; transmitting, by the one or more processors and to the user device, the voucher; and allocating, in response to receiving a payload specifying (i) a voucher identifier matching the voucher and (ii) an entity identifier matching the particular entity from the user device of the user, the amount of fractional shares in the privately held company to the user.

Yet Another aspect of the subject matter described herein includes a computer readable medium storing executable instructions that upon execution performs operations including: obtaining, by one or more processors, an allocation of shares in a privately held company that is not listed on a public stock exchange; transforming, by the one or more processors, at least a portion of the allocated shares into fractional shares that represent only a portion of the ownership provided by a single full share of the privately held company; detecting, by one or more processors, a trigger event corresponding to a user interaction with a particular entity through a platform of the particular entity separate from the one or more processors, wherein the trigger event triggers allocation of shares in the particular entity by the one or more processors to a user of a user device; determining, by the one or more processors and based on the detected trigger event, an amount of the fractional shares of the privately held company to be issued to the user; generating, by the one or more processors and based on the number of reward points and the amount of shares, a voucher that authorizes allocation of the amount of fractional shares; transmitting, by the one or more processors and to the user device, the voucher; and allocating, in response to receiving a payload specifying (i) a voucher identifier matching the voucher and (ii) an entity identifier matching the particular entity from the user device of the user, the amount of fractional shares in the privately held company to the user.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a user's interactions trigger issuance of an amount of shares in a particular corporate entity to a user

FIG. 2 is an example data flow for issuing an amount of shares in a particular corporate entity to a user in response to a verified trigger action in the example environment of FIG. 1

FIG. 3 is a flow chart of an example process for issuing an amount of shares of a corporate entity to a user in response to a verified trigger action.

FIGS. 4A-4C illustrate example user interfaces for a corporate entity user within a share management system.

FIG. 5 is a block diagram of an example computing system.

Like reference numbers and designations in the various drawings indicate like elements.

### DETAILED DESCRIPTION

This document describes methods, systems, and devices that transform full shares of a privately held company (e.g., that is not traded on a public stock exchange) into fractional shares of that company that are made available to the public in response to actions taken by members of the public. In other words, this document describes a solution that enables widespread access to these fractional shares in the absence of an exchange for obtaining shares of stock in a privately held company. This is an improvement over prior systems because those prior systems do not provide the functionality that transforms full shares of privately held companies into fractional shares that are allocated to the public based on actions performed by members of the public, and outside of a stock exchange.

The systems discussed herein can be used to reward users for brand loyalty and for performing activities designated as qualifying trigger actions, such as participating in a recycling program, volunteering for a cause, or interacting with an online presence of an entity, among other activities. Users are rewarded with brand-issued reward points, and the system described herein allows users to trade in those reward points for shares in the brand, fractional or whole. The proposed techniques facilitates the retention of existing users and the acquisition of new users who are interested in the benefits offered through the proposed reward system.

Users may be an individual, a corporation, or any other legal entity capable of acquiring goods or services. Users receive reward points by performing qualifying trigger events that are specified by a participating corporate entity. The reward points can be used through the corporate entity's existing system for rewards such as discounts or credits toward their account balance. The system described herein is linked with the corporate entity's existing system to provide additional reward options such as shares in the corporate entity.

Rewarding users for brand loyalty is an important tool in growing and maintaining a customer base. Providing users with equity ownership in entities they patronize is an effective way to help users feel invested in the success of the entity. The more a user supports and interacts with a corporate entity, the larger their participation in the corporate entity, providing a positive feedback loop that encourages further patronage and interaction with the corporate entity. Additionally, existing systems offer shares in exchange for purchases once a user has accumulated enough to purchase a full share of stock. However, waiting to accrue enough to purchase a whole share can discourage users from choosing to be rewarded with shares.

The proposed techniques and systems allow a user to convert brand-issued reward points into shares (e.g., fractional shares) in the brand's corporate entity. The proposed techniques can include checking the validity of the trigger to confirm that the user should be rewarded with shares, generating a voucher that can be exchanged for shares, verifying the voucher and issuing the shares to the user, and securely linking the user's account with the corporate entity to the user's account with the shares system. For example, a user can choose a valid amount of reward points to be exchanged for a valid amount of shares (e.g., a non-whole number of shares) and the system can generate a voucher for that amount. The user can redeem the voucher and the valid amount of shares will be issued to the user (e.g., by way of their account registered with the fractional share system).

The proposed methods and systems can also trigger the generation of a voucher based on actions other than a user-initiated exchange of reward points. For example, the system can reward a user based on detecting actions performed by the user, such as participation in a recycling program for a product of a corporate entity, logging into the corporate entity's application at certain hours of the day, participating in other programs supported by a corporate entity. These actions can be non-financial transactions that align with actions that corporate entities want to reinforce through the proposed rewards system. The amount of shares with which the user should be rewarded and for which the voucher should be generated can be calculated automatically based on the trigger.

The voucher includes sufficient information to prevent unauthorized allocation of shares, ensure that the voucher is only redeemed once, and that allocation of the shares is attributed to the correct user account. The voucher also enables the coordination between the two separate systems required to interact to facilitate the transfer of fractional shares to a user. That is, the transfer of fractional shares in a privately held company requires coordination between the fractional share system and the system of the entity that is awarding the fractional shares. In some instances, that coordination is between the fractional share system and a reward system of a privately held company that is allowing fractional shares of their stock to be allocated to the public. As described in more detail below, the coordination between these two disparate systems requires linking of accounts in each system to each other (e.g., a user's accounts in each of the disparate systems), and transferring information required to authenticate a request for fractional shares and accurately account for the transfer of those shares.

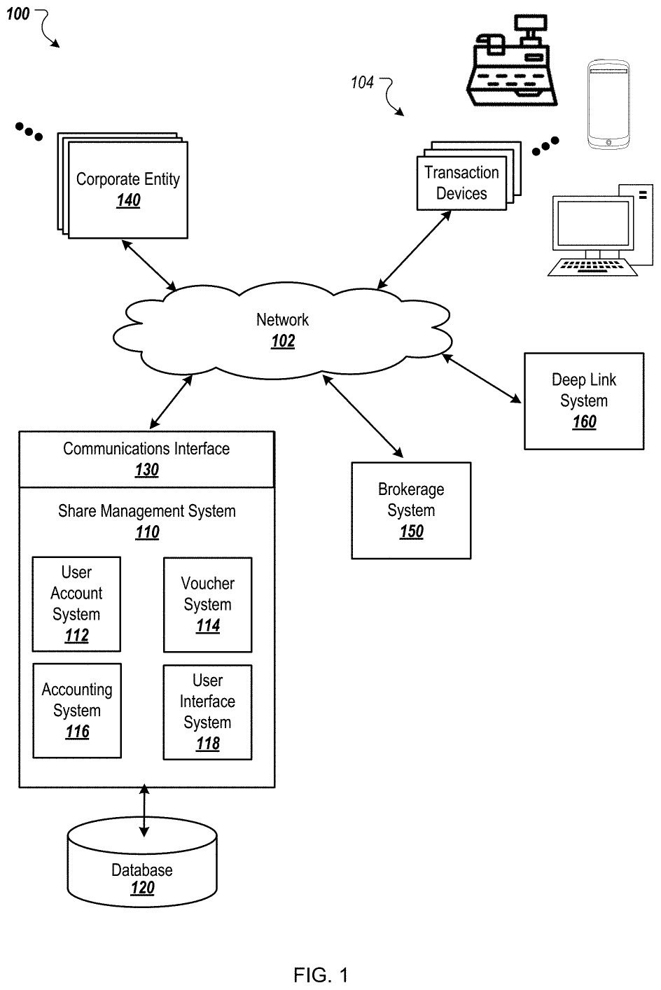

FIG. 1 is a block diagram of an example environment 100 in which a user's interactions trigger issuance of an amount of shares in a particular corporate entity to a user. The example environment 100 includes a network 102, such as a local area network (LAN), a wide area network (WAN), the Internet, or a combination thereof. Network 102 connects transaction device(s) 104, share management system 110, corporate entity 140, and brokerage system 150. The example environment 100 may include many different types of transaction devices 104 and corporate entities 140.

A transaction device 104 is an electronic device that is capable of requesting and receiving resources over network 102 to complete a transaction between a user and a corporate entity. Transaction device 104 provides a user with access to a corporate entity. In some implementations, transaction device 104 is, for example, a point-of-service (POS) terminal at a merchant's place of business. In some implementations, transaction device 104 is a user device through which a user can complete a transaction with a corporate entity. Example user devices 104 include personal computers, mobile communication devices, and other devices that can send and receive data over network 102. In some examples, user device 104 is a mobile device, such as a cellphone, a virtual reality device (e.g., implemented in a headset or other device such as a combination of a speaker and a display), a smartphone, a personal digital assistant (e.g., implemented in a tabletop speaker or other device such as a combination of a speaker and a display), or a tablet, and communicates over a wireless network. A user device 104 typically includes a user application, such as a web browser, to facilitate the sending and receiving of data over network 102, but applications executed by user device 104 can also facilitate the sending and receiving of data over network 102.

Corporate entity 140 is an entity that offers equity, such as shares of stock. Corporate entity 140 can be a privately held corporation whose shares are not listed on a public stock exchange or traded in any public stock market. In some implementations, one or more of the corporate entities 140 of system 100 can be a publicly listed corporation whose shares are traded in a public stock exchange. Corporate entity 140 participates in the reward structure offered by system 110, and each corporate entity 140 can define trigger actions for which a user can be rewarded with shares, as well as the fractional amount of shares that a user can earn for each qualifying trigger action.

Corporate entity 140 offers a user interface through which users can manage accounts and loyalty rewards provided by corporate entity 140. For example, corporate entity 140 can offer an application through which a user can perform actions such as view and update their profile information, manage reward points, and perform transactions with corporate entity 140, among other actions. Corporate entity 140 offers rewards to customers for their loyalty. For example, corporate entity 140 can provide a user with reward points for completed transactions and other trigger actions defined by corporate entity 140.

The amount and type of shares available to be issued to users of share management system 110 is specified by corporate entity 140. For example, corporate entity 140 can specify to share management system 110 that 20,000 shares of Special Class A stock are available to be issued to users of share management system 110.

In order to set aside the shares to be allocated by share management system 110, private companies such as corporate entity 140 can transfer or donate a specific amount of shares to a separate legal entity, such as a special-purpose vehicle or private foundation. Share management system 110 can then fractionalize the assets held at the separate legal entity and allocate them to the users.

Once share management system 110 receives this allocation of shares in corporate entity 140, share management system 110 transforms at least a portion of these allocated shares into fractional shares that represent only a portion of the ownership provided by a single full share of corporate entity 140. For example, accounting system 116 can transform the 200 shares of Special Class A shares into 2000 fractional shares of Special Class A shares. In this example, each of the fractional shares represents 1/10 of the ownership provided by a single full share of Special Class A shares in corporate entity 140.

The coordination between share management system 110 and corporate entity 140 is particularly beneficial to users by providing a seamless experience that allows users wider access to shares of privately held companies that are not traded on an open exchange, and therefore not generally available to the public. Additionally, because share management system 110 manages and facilitates the distribution of fractional shares, the system allows users to obtain ownership in a privately held company even if the user does not have an aggregate amount of rewards sufficient to purchase a full share of stock.

Database 120 stores brokerage account information, financial institution account information, reward system account information, and participating corporate entity information. Database 120 can store data relationally. For example, a user's brokerage account can be indexed to a verified bank account of the user's, the user's reward system account, and other user information.

Share management system 110 is a system that detects and validates user actions that trigger the system to generate and/or execute an order for shares. Share management system 110 facilitates the rewarding of users for their loyalty to corporate entities and other entities that offer shares of the organization. For example, share management system 110 makes it possible for entities to participate in a program that provides users with a reward of shares in the entity itself to promote loyalty and to give users a stake in the entity and its success. Users who wish to participate in share management system 110 create an account with share management system 110. When users create share management system accounts, they register for share management system 110 and have the option of selecting corporate entities 140 with whom they have accounts that they would like to be linked with share management system 110.

Share management system 110 receives information, such as transaction information, and determines whether the information indicates one or more trigger actions, such as selecting a valid amount of reward points to be exchanged for a valid amount of shares. Upon detecting a trigger action related to a user and a particular corporate entity, share management system 110 determines whether the corporate entity participates in share management system 110 and whether the user has selected the corporate entity as one from whom they would like to receive share rewards.

Share management system 110 maintains accounts of participating users. Share management system 110 communicates with database 120 to store and maintain user and corporate entity accounts and information. In some situations, users may not claim their stock rewards until a brokerage account is created with share management system 110. In some implementations, in order to generate and place market orders with brokerage system 150 on behalf of users, share management system 110 must create and/or manage a brokerage account for each user. In some implementations, share management system 110 must authenticate a bank account of the user's. Further details on the authentication process are provided below. Share management system 110 can also maintain reward system accounts of users. These accounts are linked to information such as a user's brokerage account created and/or managed by share management system 110 and historical user activity information. Share management system 110 also maintains information on participating corporate entities. Share management system 110 communicates with other systems, such as corporate entities 140 that wish to participate in share management system 110, and users of transaction devices 104. Share management system 110 includes a user account system 112, a voucher processing system 114, an accounting system 116, a user interface system 118, and a communications interface 130.

User account system 112 manages accounts for customers of participating corporate entities and for the participating corporate entities themselves. User account system 112 is able to securely verify user account information and link accounts. For example, user account system 112 can link a customer's share management system account with the customer's corporate entity rewards account.

Voucher processing system 114 facilitates detection and verification of trigger events performed by a user of client device 104. These events trigger the generation of a voucher that can be redeemed for shares that are issued to the user. Voucher processing system 114 determines, based on the verification of a trigger event, an amount of shares (fractional or whole) to be issued to a user who has performed the trigger event.

Trigger events, or events (e.g., a user's actions or interactions) that trigger the generation of a voucher that can be redeemed for an amount of shares on behalf of the user, are specified by corporate entities 140 participating in share management system 110. Actions such as selecting a valid amount of reward points to be exchanged for a valid amount of shares, purchasing particular items from a participating corporate entity 140, or paying a subscription fee for a product or service from a participating corporate entity 140 can be defined as trigger events, among other actions. For example, an online streaming service can define payment of a monthly subscription fee as a qualifying trigger action. In some implementations, signing up for a monthly subscription to the online streaming service can be defined as a qualifying trigger action, while paying the subscription fee each month is not a qualifying trigger action. Other actions related to a participating corporate entity 140 can be designated as a trigger event, such as interacting with a corporate entity through providing feedback, participating in a survey, promotional event, or program specified by the corporate entity, and interacting with an online presence of the entity, among other user actions. For example, a particular corporate entity 140 can designate participating in a recycling program of products from entity 140 as a trigger event. Some actions can be non-financial in nature and can relate to behavior that corporate entities want to reinforce through the proposed rewards system.

Trigger events also include actions unrelated to transactions or interactions with a participating corporate entity. For example, a particular corporate entity 140 that promotes health can designate joining any gym and attending at least five classes as a trigger event. In some implementations, detecting such trigger events may include monitoring platform(s) of entities that a user may interact with for data that can qualify as trigger events. In some implementations, detecting such trigger event may include receiving data from the platform(s) indicative of the user's interaction with the platform(s) and automatically determining, e.g., in real-time or quasi real-time, if the data qualifies as a trigger event or not.

For some actions, the date of the transaction can differ from the date the transaction is executed. For example, a purchase made through a user's credit card may remain pending for several days before it posts to the user's account. In some implementations, the purchase can be the trigger event. For example, share management system 110 may allow corporate entities 140 to designate a purchase transaction as a trigger event as soon as a user makes a purchase and the transaction becomes pending on the user's credit card. In such situations, the transaction has not yet posted to the user's account, and thus funds have not been deducted, but the transaction has been approved. In some implementations, share management system 110 allows corporate entities 140 to designate the posting of the purchase to the user's account as a trigger event. For example, a corporate entity 140 may want to wait until funds have been deducted from a user's account before providing a reward.

Share management system 110 verifies trigger events to ensure that user actions are valid qualifying trigger events for which a voucher should be generated. Share management system 110 uses data indicating characteristics of a transaction that is detected as a trigger event and compare the data to confirmed transaction data. For example, a user can purchase a product from participating corporate entity 140 and once the transaction is marked as posted, share management system 110 detects data indicating characteristics of the purchase. Share management system 110 can then compare the detected data with confirmed details of the transaction. In some implementations, share management system 110 can compare data indicating characteristics of the trigger event with confirmed data of a later event. For example, share management system 110 can compare data of a pending transaction with the confirmed details of the transaction once the transaction has posted.

Once a trigger event has been verified, share management system 110 determines an amount of shares of a particular corporate entity 140 to be provided to a user of share management system 110 as a reward. For example, corporate entity 140 can specify an exchange rate for reward points to shares, and share management system 110 can then convert a user's input of a number of reward points to shares. In some implementations, corporate entity 140 can specify an exchange rate for reward points to shares and inform the user and share management system 110 of the amount of shares that should be issued to the user. In some implementations, corporate entity 140 can specify an exchange rate for reward points to points within the share management system 110, and share management system 110 can determine an amount of shares to be issued to a user for a particular number of reward points. A user can select either a number of reward points or a number of shares, and share management system 110 can verify the action and subsequently issue a voucher for the appropriate amount of shares.

Users can receive, for example, a portion of their transaction amount with a participating corporate entity 140 to be used for a market order of a fractional share in corporate entity 140. For example, if a user makes a $50 purchase from a home improvement store, the home improvement store entity can offer 2% of the $50 purchase amount, or $1, to be used for a market order of a share in the home improvement store entity. The $50 purchase would result in $1 worth of corporate entity 140's stock being procured and deposited in the user's brokerage account. In some implementations, the user can choose to sell the stock and convert the share reward into a cash reward of $1 or the user can choose to keep the share for future sale.

Each participating corporate entity with which a user has a rewards account can be linked to the user's share management system account by share management system 110. For example, share management system 110 can generate a mapping of participating corporate entities 140 that a particular user has agreed to link. These mappings can be stored in database 120 with other reward system account data.

Accounting system 116 manages the records for share management system 110 and provides updates to corporate entity 140 to ensure that the records kept by the two systems are consistent. Accounting system 116 maintains records for share management system 110 within database 120 and can generate update data to be transmitted to corporate entity 140 regarding the reward points balance and amount of shares to be deducted from the pool allocated to be issued to users of share management system 110. Additionally, accounting system 116 maintains a registry and sub accounting of shareholders for reporting to corporate entity 140.

Brokerage system 150 facilitates the buying and selling of securities, such as debt securities, equity securities, and/or derivatives through a market. For example, brokerage system 150 can facilitate the exchange of securities through a public market such as the New York Stock Exchange, the London Stock Exchange, and the Shanghai Stock Exchange, etc. Brokerage system 150 can facilitate the exchange of securities of privately held corporates through, for example, a private market. Brokerage system 150 manages brokerage accounts of users of brokerage system 150. Currency is deposited into brokerage accounts for users to buy securities through brokerage system 150. Brokerage system 150 receives a market order and fulfills the market order by depositing ordered shares in respective users' brokerage accounts.

In some implementations, share management system 110 can, for example, manage users' brokerage accounts with brokerage system 150 such that an amount to be deposited in a user's brokerage account can fund the purchase of a determined fractional number of shares of a particular corporate entity 140. For example, if a particular corporate entity 140 is a publicly listed company, share management system 110 can generate a market order for the determined fractional number of shares of the particular corporate entity 140 and provide the order to a brokerage system, such as brokerage system 150 for execution. Share management system 110 can aggregate fractional amounts of shares of particular corporate entities across all reward system accounts and generate aggregate market orders. Once the market order has been fulfilled, brokerage system 150 can deposit fractional shares in particular users' brokerage accounts.

Deep link system 160 receives information and generates a resource identifier that directs a receiving device to a specific location with specific parameters within an application or system rather than simply launching the application or system. In some implementations, deep link system 160 is a third party system that securely generates deep links for share management system 110. In some implementations, deep link system 160 can be a module within share management system 110.

Communications interface 130 provides a connection between share management system 110 and users of the system, such as corporate entities 140 and transaction devices 104.

Communications interface 130 allows, for example, voucher processing system 114 to communicate with other devices through network 102.

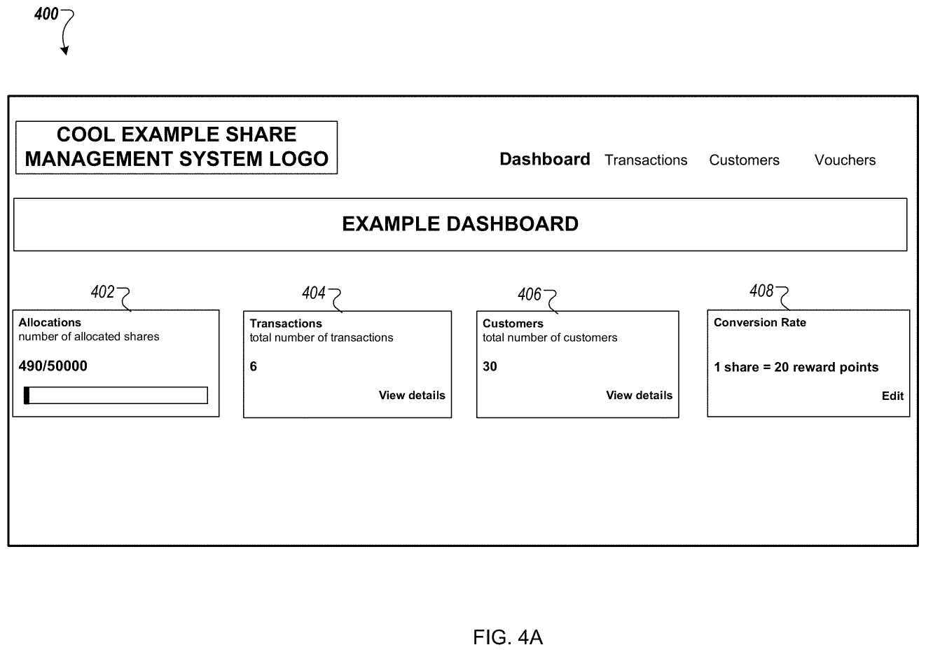

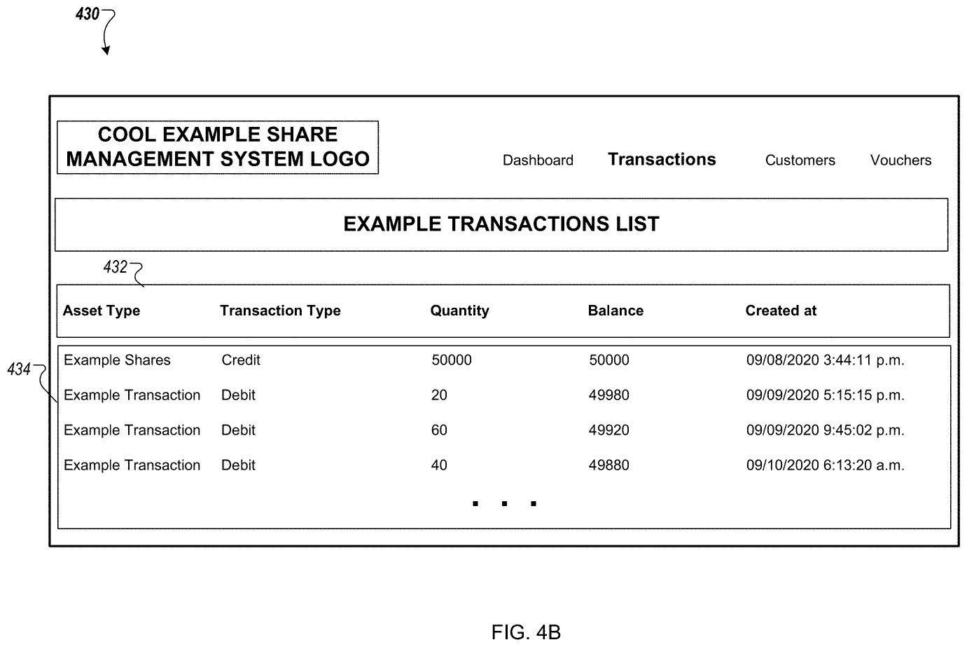

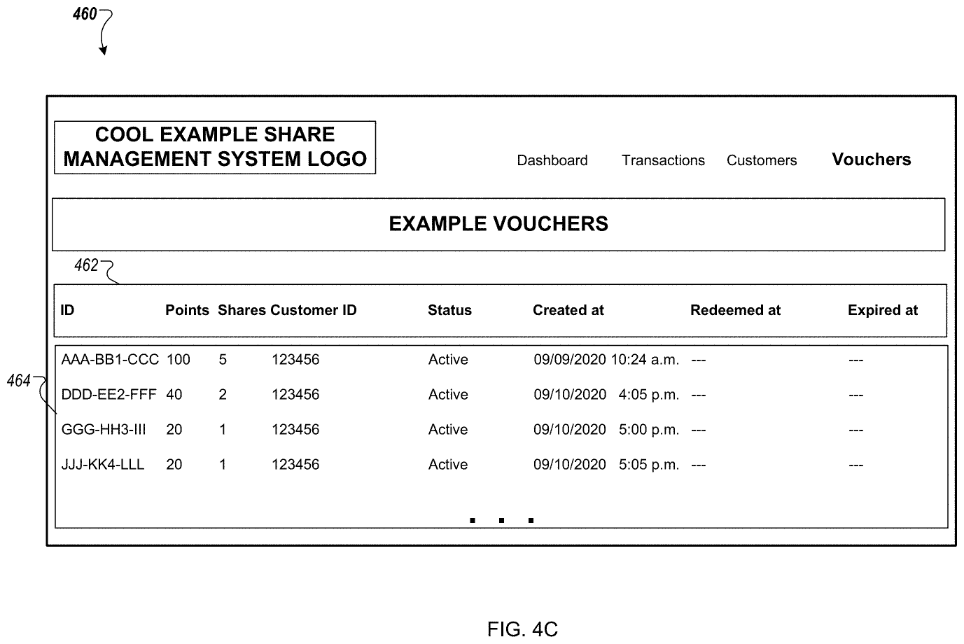

Share management system 110 provides a user interface for users of the system itself and for the corporate entities 140 with which share management system 110 is linked. Details of account management and actions that users can take through communications interface 130 are provided below with respect to FIGS. 4A-C. For example, share management system 110 includes an application programming interface (API) that allows share management system 110 to be used by different systems and corporate entities to detect when an action that qualifies as a trigger event is performed. For example, share management system 110 may be implemented as an open source system that can be integrated with multiple different transaction processing platforms.

Users of share management system 110 can access a user interface generated and maintained by user interface system 118 through communications interface 130. The user interface and inputs received through the user interface are processed by user interface system 118. The user interface allows users to perform actions such as manage their profile information, initiate the linking of a rewards account from a corporate entity 140, and/or initiate a trigger event by selecting a number of reward points for a particular corporate entity 140 to be exchanged for shares in that corporate entity 140, among other actions. For example, a user can select a number of reward points for a local farm 140 to be redeemed for shares of the local farm 140.

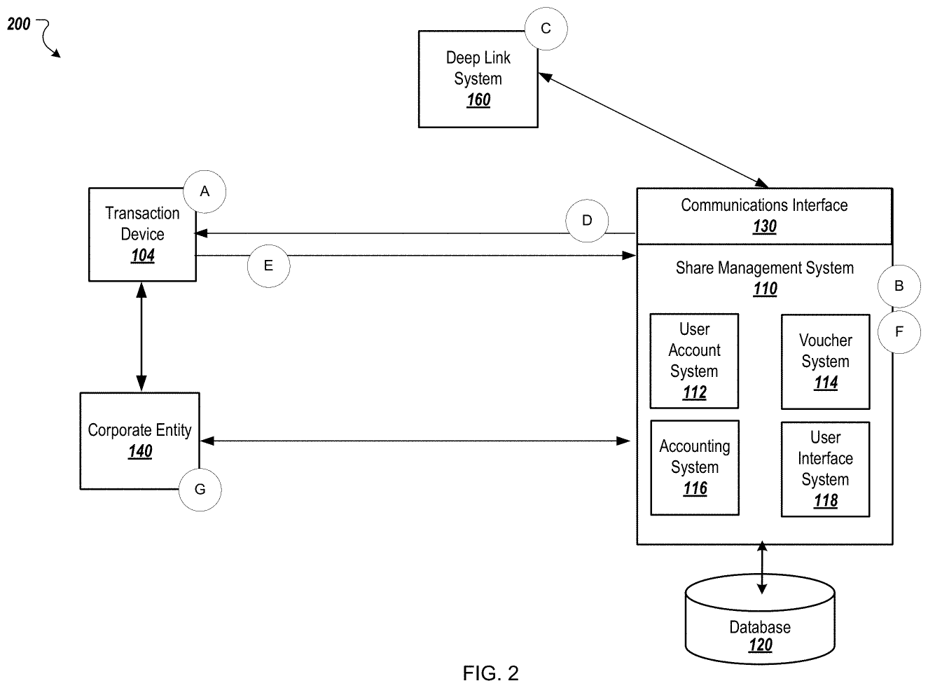

FIG. 2 is an example data flow 200 for issuing an amount of shares in a particular corporate entity to a user in response to a verified trigger action in the example environment of FIG. 1. Operations of the data flow 200 are performed by the share management system 110. Stages of the flow 200 are performed within a network environment, such as the environment 100.

In some implementations, operations of the data flow are performed automatically upon execution of executable instructions by the systems disclosed herein. The operations may be automatically performed in real-time or quasi real-time.

Prior to stage (A), share management system 110 receives an allocation of shares in a privately held company that is not listed on a public stock exchange. For example, the privately held company is corporate entity 140. Corporate entity 140 participates in share management system 110, and provides an allocation of an amount and type of shares. For example, corporate entity 140 can provide share management system 110 with 200 shares of Special Class A shares that are specifically created to be allocated through share management system 110.

Share management system 110 transforms at least a portion of these allocated shares into fractional shares that represent only a portion of the ownership provided by a single full share of corporate entity 140. For example, accounting system 116 can transform the 200 shares of Special Class A shares into 2000 fractional shares of Special Class A shares. In this example, each of the fractional shares represents 1/10 of the ownership provided by a single full share of Special Class A shares in corporate entity 140.

Data flow 200 begins with stage (A), in which a user action specified as a trigger action, is detected by share management system 110. For example, a user action specified as a trigger action by corporate entity 140 is detected by share management system 110. In some implementations, share management system 110 receives data indicating a verified trigger action through corporate entity 140. For example, if a share management system 110 user links their frequent flyer account to share management system 110 and the account is authenticated, trigger actions can be detected and verified by corporate entity 140. Corporate entity 140 can specify, for example, that reaching a certain number of frequent flyer miles within a period of time, flying a certain number of legs, among other activities, qualify as trigger actions for which a user can be rewarded with fractional amounts of shares in corporate entity 140. In another example, a share management system 110 user can link their corporate entity 140 branded credit card to share management system 110. Once the credit card account is authenticated, for example, through data aggregator 120, share management system 110 can reward qualifying purchases made using the linked credit card with shares of corporate entity 140 in addition to the existing benefits of the branded credit card.

In some implementations, share management system 110 receives data from corporate entity 140 indicating the trigger action. For example, corporate entity 140 can implement the API for share management system 110 through the user interface system 118 such that corporate entity 140 detects and validates an action performed by a user as a qualifying trigger action. In some examples, corporate entity 140 can detect and validate a user's completion of a number of purchases made in a given amount of time as a qualifying trigger action. The data from corporate entity 140 can indicate that the user performed a particular user interaction other than a financial transaction. For example, if participating in a coffee capsule recycling program for coffee maker 140 is designated as a trigger action by coffee maker 140, coffee maker 140 can determine whether a user has performed a qualifying trigger action and provide details of the trigger action to share management system 110. Details of the trigger action include, for example, a description of the action itself (such as a categorization, a narrative description, etc.), a time for the action (such as the time at which the action occurred or the time at which the action qualified as a trigger action), and user information for the user who performed the qualifying trigger action.

In some implementations, corporate entity 140 can designate certain actions as qualifying trigger actions, and other devices and systems can determine whether a user has completed a qualifying trigger action. For example, if tagging corporate entity 140 through a social media application is a trigger action, user device 104 through which the user has tagged corporate entity 140 can detect the action and provide details of the action to share management system 110. In some implementations, qualifying trigger actions can include actions performed with a partner of corporate entity 140. For example, the act of volunteering at a charity event for a nonprofit for which corporate entity 140 is a sponsor can be designated as a trigger action. The nonprofit can provide participation information to corporate entity 140 for processing. In some implementations, corporate entity 140 can authorize its partner to provide this information directly to share management system 110 for processing.

In another example, share management system 110 can detect a trigger action performed by a user and involving a particular corporate entity 140, such as a user transaction with corporate entity 140. For example, share management system 110 can receive transaction data from a third party data aggregator. In this example, the transaction data is data indicating a credit card transaction in which the user pays in-store at a POS terminal 104 for a product from corporate entity 140. In some implementations, share management system 110 retrieves data from a data aggregator periodically. For example, share management system 110 can retrieve transaction data from a data aggregator at the end of every hour, every day, every week, etc. In some implementations, share management system 110 receives data from a data aggregator when new data becomes available. For example, share management system 110 can receive credit card transaction data from data aggregator 120 whenever a participating user of transaction device 104 completes a purchase with a credit card.

In some implementations, receiving data indicating a trigger action can include receiving transaction post data indicating the transaction between the user and corporate entity 140 has posted to a user account indexed to the user's brokerage account. For example, share management system 110 can receive data indicating that a purchase made by a user from a shoe manufacturer 140 has posted to the user's credit card account or bank account that is indexed to the user's brokerage account in database 120.

Data flow 200 continues with stage (B), in which voucher processing system 114 determines, based on the trigger event data, an amount of shares of corporate entity 140 for which a voucher should be issued to the user, and generates the voucher.

Share management system 110 can first verify the trigger action. Share management system 110 determines whether, for example, the exchange transaction between the user and a particular corporate entity qualifies for a reward. Share management system 110 can determine whether the user has a share management system account. Share management system 110 can then determine whether the user has linked the particular corporate entity in their reward system account. Share management system 110 may not proceed with generating a voucher for issuing an amount of shares to the user in exchange for a number of reward points if the trigger action is not validated.

Share management system 110 can verify the trigger action using, for example, the transaction data received. This transaction data can include a corporate entity identifier, a description of the transaction (such as a category, a narrative description, etc.), an amount of the transaction, a time of transaction, etc.

In some implementations, share management system 110 can determine that a trigger event is a qualifying trigger event, but that the shares cannot be issued. For example, if share management system 110 determines that the number of reward points specified by the user to be exchanged for an amount of shares is less than the number of reward points available in the user's rewards account, share management system 110 can determine that the user has insufficient reward points. In some implementations, corporate entity 140's rewards system can determine that the user has insufficient reward points and may not transmit the trigger event data to share management system 110. In another example, if share management system 110 determines that the amount of shares to be issued to the user in exchange for a number of reward points is larger than the number of shares available to be distributed to users of share management system 110, share management system 110 can determine that the shares cannot be issued. In some implementations, corporate entity 140's rewards system can determine that there are insufficient shares and may not transmit the trigger event data to share management system 110.

Additionally, share management system 110 must determine whether the user has an account with share management system 110. User account system 112 of share management system 110 can consult, for example, database 120 to determine whether the user has an account with share management system 110. Regardless of whether the user has an account with share management system 110, share management system 110 can generate a voucher for the shares, but the redemption process may differ, as described in detail below.

Once the trigger events has been verified, voucher system 114 will generate a voucher that can be redeemed for shares. The voucher includes a unique identifier for the voucher, or a voucher ID, and an identifier for the corporate entity 140, or a brand ID. In some implementations, the voucher indicates the number of reward points to deduct from the user's account and the amount of shares to be issued to the user. In some examples, the voucher does not include this information, which is instead stored within share management system 110 and provided to share management system 110 and corporate entity 140 upon redemption of the voucher. In some implementations, the voucher can include, for example, a user identifier that indicates the user's account with share management system 110 or with the corporate entity 140. If the user does not yet have an account with share management system 110, the voucher does not indicate the user's account with share management system 110, and instead can flag the voucher to indicate that the user does not yet have an account with share management system 110.

Corporate entity 140 can specify an expiration date or period for the voucher for security purposes. For example, corporate entity 140 can provide a date on which a particular voucher will expire and can no longer be redeemed for shares. The expiration date or period can vary based on characteristics of the trigger event. For example, corporate entity 140 can specify that each voucher generated for a reward points redemption will expire at the end of 120 days, while each voucher generated for completing a promotional activity by tagging corporate entity 140 in a post on a social media website will expire at the end of 10 days. When the voucher is generated by voucher system 114, the time and date of creation can be stored in the journal entry to be compared to the current time and date, or from which to calculate a period of time for which the voucher has been outstanding.

Accounting system 116 of share management system 110 can update the records for share management system 110 and provide an update to corporate entity 140. For example, the voucher is stored as a journal entry in database 120. The journal entry includes voucher information, including the voucher ID, the brand ID, the status of the voucher, the number of reward points to be deducted from the user's rewards account with corporate entity 140 and the amount of shares to be issued to the user.

Upon creation of the voucher, accounting system 116 creates the journal entry and indicates that the voucher is active. The journal entry indicates that there is a hold on the reward points and on the amount of shares, such that an over-allocation of shares or points does not occur. Accounting system 116 ensures that reward points are not deducted from the user's rewards accounts until shares have been issued to the user by placing a hold on the points in the amount specified by the voucher. Accounting system 116 either releases the points upon expiration of the voucher or deducts the points from the user's rewards account when the voucher is successfully redeemed.

Data flow 200 continues with stage (C), in which share management system 110 communicates the voucher information to deep link system 160 to generate a deep link. The deep link provides a secure, convenient way to link share management system 110 and corporate entity 140. The deep link directs a user to a specific location within share management system 110 using a resource locator such as a Uniform Resource Locator (URL).

If the user has an account with share management system 110, the information provided by share management system 110 will indicate the user's account information, and the deep link can include a payload that provides the user's account identifier and credentials.

If the user does not have an account with share management system 110, the information provided by share management system 110 will indicate that the user does not have an account with share management system 110, and the deep link will direct the user to create an account. In this situation, the deep link is a deferred deep link that will initially direct the user to install or download the share management system 110 and/or create an account with the share management system 110. Once the application is installed and/or the account is created, the deep link is invoked again with its original parameters, including the voucher redemption information, such that the share management system 110 can handle the invocation.

By incorporating the use of deep linking and the linking of a user's rewards account with share management system 110, the system 100 provides a seamless experience to the user once the initial set-up is complete. The system allows users to bypass further authentication and prevents users from being asked for further input on subsequent transactions when exchanging reward points for shares. The system 100 reduces the amount of authentication traffic required for each subsequent transaction, and improves security for the user's account overall by restricting the vouchers to use within share management system 110.

The flow continues with stage (D), in which share management system 110 transmits the deep link to redeem the voucher to the user of transaction device 104. For example, share management system 110 can forward the deep link along with a payload to be provided to the user that includes voucher information. In some implementations, deep link system 160 can provide the deep link directly to the user of transaction device 104.

The flow continues with stage (E), in which the user of transaction device 104 interacts with the deep link to redeem the voucher. The user can click the link and be directed to share management system 110.

The flow continues with stage (F), in which share management system 110 processes the voucher redemption based on the user's action. For example, the deep link can include a payload that is provided to share management system 110 once transaction device 104 is directed to share management system 110. The payload can provide the information necessary to redeem the voucher, including the voucher ID and the brand ID.

If the user has an account with share management system 110, the transaction device 104 can provide information such as user account information for the share management system 110 when it directs the user to share management system 110. If the user does not have an account with share management system 110, the deep link will direct the user to share management system 110 to create an account.

The user can, for example, create an account by providing input to user interface system 118 through communications interface 130. Once the user creates an account with share management system 110, the account is linked with the user's account with corporate entity 140 for which the shares are issued. The account credentials linking share management system 110 with the user's rewards account with corporate entity 140 can be stored in database 120.

The account verification process occurs only for the first transaction with a particular corporate entity 140. Once the user's share management account has been verified and the transaction has been processed, share management system 110 is authenticated and linked to the user's existing reward account issued by the corporate entity 140 for subsequent transactions. This provides users with a seamless experience, allowing users to bypass tedious verification steps in later transactions with the corporate entity 140.

After the account verification process, or if the user's share management system 110 account is already linked with the user's rewards account with corporate entity 140, share management system 110 calls voucher system 114 to validate and process the voucher. Voucher system 114 can verify that the voucher information provided through the deep link is for a valid, active voucher by verifying the voucher ID, status, and expiration date of the voucher. For example, if the voucher has already been redeemed, the voucher's status in the journal entry stored in database 120 would indicate that it has been redeemed, or is no longer active. Voucher system 114 can determine whether the voucher is expired by comparing the expiration date of the voucher to the current date or by calculating a period of time since the creation of the voucher to determine whether the expiration period has lapsed.

If the voucher is expired or no longer active, voucher system 114 can inform accounting system 116, and accounting system 116 can update the journal entry for the voucher stored within database 120 to indicate that the voucher is no longer active. For example, account system 116 can update the journal entry linked to the voucher ID indicated by the payload from the deep link.

In some implementations, if the voucher is expired but has not yet been redeemed, share management system 110 can automatically create a new voucher to be redeemed instantly. In some implementations, share management system 110 can communicate the expiration to corporate entity 140. Corporate entity 140 can then determine whether to issue a new voucher, for what amount the voucher should be issued, etc.

Upon verifying that the voucher is not expired, voucher system 114 can process the redemption of the voucher by allocating the amount of shares indicated in the journal entry for the particular voucher accounting system 114, and accounting system 116 can update the journal entry for the voucher stored within database 120 to indicate that the voucher has been redeemed. In order to balance the records, accounting system 116 updates the journal entry for the customer as a credit in the amount of shares indicated in the voucher and as a debit from the pool of shares available to be allocated by share management system 110 for corporate entity 140.

The flow concludes with step (G), in which share management system 110 provides an update to corporate entity 140 regarding the redemption. For example, if the voucher was unsuccessfully redeemed, accounting system 116 can release the hold on the reward points and the shares and transmit an update to corporate entity 140 indicating the release of the points and the shares back into the pool of shares available to be allocated by share management system 110 for corporate entity 140. If the voucher was successfully redeemed, accounting system 116 transmits an update to corporate entity 140 indicating a credit in the amount of shares indicated in the voucher and a debit in the amount of reward points indicated in the voucher.

In some implementations, in order to generate and place market orders on behalf of a user with brokerage system 150 when managing shares for a publicly listed corporate entity, share management system 110 creates and/or manages a brokerage account for the user. The fractional shares for which share management system 110 generates and places market orders on behalf of users can be deposited in the respective user's brokerage account. In order to create a brokerage account on behalf of a user, share management system 110 must verify the user's identity and can use a third-party verification system such that sensitive information such as bank account information is not directly transmitted between share management system 110 and the user, authenticating the user's bank account without providing the log in information directly to share management system 110.

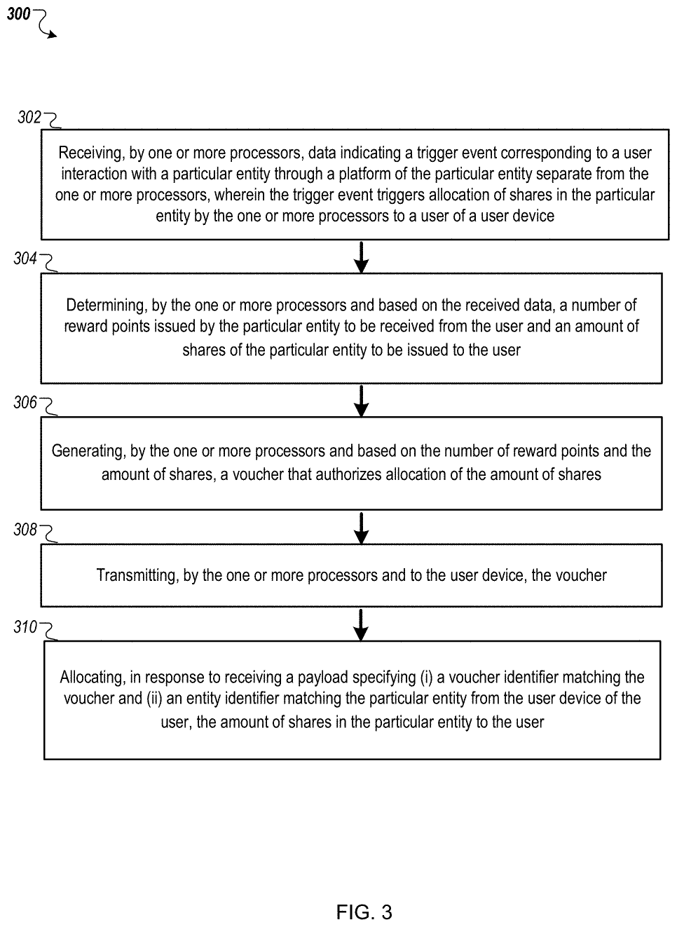

FIG. 3 is a flow chart of an example process 300 for issuing an amount of shares of a particular corporate entity to a user in response to a verified trigger action. In some implementations, operations of the process 300 can be implemented by a share management system. For example, operations of the process 300 can be implemented by share management system 110 of FIGS. 1-2. In some implementations, the process 300 can be implemented as instructions stored on a non-transitory computer readable medium, and when the instructions are executed by a user device, the instructions can cause the user device to perform operations of the process 300.

Process 300 begins with obtaining, by one or more processors, an allocation of shares in a privately held company that is not listed on a public stock exchange (302). For example, share management system 110 receives an allocation of 200 shares of Special Class A shares in corporate entity 140, which is a privately held company. The Special Class A shares can be, for example, shares that are specifically created to be allocated through share management system 110.

Process 300 continues with transforming, by the one or more processors, at least a portion of the allocated shares into fractional shares that represent only a portion of the ownership provided by a single full share of the privately held company (304). For example, accounting system 116 of share management system 110 can transform 50 of the 200 shares of Special Class A shares into 50000 fractional shares of Special Class A shares. In this example, each of the fractional shares represents 1/1000 of the ownership provided by a single full share of Special Class A shares in corporate entity 140.

Process 300 begins with receiving, by one or more processors, data indicating a trigger event corresponding to a user interaction with a particular entity through a platform of the particular entity separate from the one or more processors, wherein the trigger event triggers allocation of shares in the privately held company by the one or more processors to a user of a user device (306). In some implementations, the particular entity and the privately held company are the same entity. For example, a user can interact with corporate entity 140 through an application for corporate entity 140. In some implementations, the particular entity is different from the privately held company. For example, the particular entity can be a recycling center that partners with corporate entity 140 to encourage customers of corporate entity 140 to recycle. In some implementations, receiving data indicating a trigger event includes receiving data indicating that the user selected at least one of the number of reward points and the amount of shares of the particular entity. For example, share management system 110 can receive data indicating that a user of transaction device 104 has selected a number of reward points to exchange for an amount of shares in corporate entity 140 through an application user interface maintained by corporate entity 140. The user's selection of reward points to exchange for an amount of shares is a trigger event. In some implementations, receiving data indicating a trigger event includes receiving data indicating that the user performed a particular user interaction other than a financial transaction. For example, share management system 110 can receive data indicating that the user logged into the application of corporate entity 140 for three days in a row. In some implementations, the trigger event is participation in a program, such as a promotional event, specified by the corporate entity 140. For example, the trigger event can be participating in a recycling event.

Process 300 continues with determining, by the one or more processors and based on the received data, an amount of fractional shares of the particular entity to be issued to the user (308). For example, share management system 110 can determine, based on the received data that the user selected reward points provided by corporate entity 140 to exchange for 20 fractional shares in corporate entity 140 to be issued to them. In this example, the amount of shares is less than a single whole share of Special Class A shares. In other examples, the amount of shares can add up to one or more whole shares. For example, share management system 110 can determine, based on the received data, that the user selected 10000 reward points to exchange for 2000 fractional shares in corporate entity 140 to be issued to them, which adds up to 2 whole Special Class A shares.

In some implementations, the reward points can be provided by the corporate entity 140. In some implementations, the reward points can be provided by the particular entity. For example, the recycling center can provide reward points for each can that the user recycles. In this example, the particular entity providing the points is partnered with the privately held company to encourage a specific activity, such as recycling.

In some implementations, process 300 includes determining that the particular entity has mapped the particular user interaction to a particular fractional share factor and determining a performance level corresponding to an amount of the particular user interaction performed by the user, wherein determining a fractional number of shares of the particular entity to obtain through the market transaction on behalf of the user comprises determining the fractional number of shares based on a mathematical operation applied to the fractional share factor and the performance level. For example, share management system 110 can allocate a predetermined fractional portion of a share to the user based on the type of trigger action the user has performed. Corporate entities 140 can map a particular user interaction to a particular fractional share factor. In some implementations, when the action is not a financial transaction, corporate entities 140 can map the interaction to a predetermined fractional portion of a share. For example, corporate entity 140 can specify that tagging corporate entity 140 in a social media post can be rewarded with 0.0001% of a share. In some implementations, the fractional share factor can be an equation with a resulting value that changes based on parameters of the detected action. For example, if a user that tags corporate entity 140 in a social media post has 100 k followers, the user may receive more of a share than if the user has 1 k followers. In some implementations, the equation can be linear with respect to certain parameters. In some implementations, the equation can be nonlinear with respect to certain parameters. For example, if a user posts a series of photos with a hashtag specified by corporate entity 140, each successive photo can be associated with an exponentially higher fractional amount of a share as a reward, up to a maximum threshold.

In some implementations, share management system 110 can determine a performance level corresponding to an amount of the particular user interaction performed by the user. Processor can determine the fractional number of shares based on a mathematical operation applied to the fractional share factor and the performance level. The performance level can be a quantitative assessment. For example, share management system 110 can determine that a user has posted 16 photos, 14 of which are different, of corporate entity 140's product. Share management system 110 can reward the user, for example, only for the distinct photos, such that the performance level is 14 and the fractional share factor is multiplied by 14. In some implementations, users can earn more rewards if other users interact with their previously posted interactions. For example, if a user posts photos of corporate entity 140's athletic pants and other users interact with the photos, the user may earn more fractional amounts of shares, or may only earn rewards for those photos with which other users interacted. Share management system 110 can adjust the fractional amount of shares with which a user will be rewarded, for example, within a period of time, such as a promotional period or an evaluation period. The performance level can be a qualitative assessment. For example, share management system 110 can determine whether the user has posted a several hundred word review about one of corporate entity 140's products and has included photos (i.e., a high quality review), or whether the user has simply posted a rating of the product (i.e., a lower quality review). Share management system 110 can adjust the fractional amount of shares that a user receives based on a sliding scale of the quality of the trigger action. For example, if all participating users who perform a particular trigger action generally have high quality actions, the threshold between fractional amounts of shares that a user receives for performing the particular trigger action can be commensurately higher.

Process 300 continues with generating, by the one or more processors and based on the amount of shares, a voucher that authorizes allocation of the amount of fractional shares (310). For example, voucher system 114 of share management system 110 generates a voucher for 20 fractional shares in corporate entity 140 to be issued to the user who redeems the voucher.

Process 300 continues with transmitting, by the one or more processors and to the user device, the voucher (312). In some implementations, the deep link is generated by share management system 110. In some implementations, transmitting the voucher includes transmitting, to a deep link system such as deep link system 160, the voucher, receiving, from deep link system 160, a deep link that includes a payload that specifies the voucher identifier and the entity identifier, and transmitting the deep link to the user device. For example, share management system 110 can transmit the voucher to the user device through a deep link generated by deep link system 160.

Process 300 continues with allocating, in response to receiving a payload specifying (i) a voucher identifier matching the voucher and (ii) an entity identifier matching the privately held company from the user device of the user, the amount of fractional shares in the privately held company to the user (314). For example, in response to receiving a payload from the transaction device 104 following the deep link and determining that the voucher is valid and not expired, share management system 110 allocates 20 fractional shares to the user of transaction device 104.

Process 300 can also include updating, in response to allocating the amount of shares in the particular entity to the user and by the one or more processors, a record of the voucher, and providing, by the one or more processors, data specifying (i) a debit for the amount of shares against a pool of available shares of the particular entity and (ii) a credit for the amount of shares to the user. For example, after allocating the shares, share management system 110 updates its own records and provides an update to corporate entity 140 to synchronize the records of the two systems.

FIGS. 4A-4C illustrate example user interfaces 400, 430, 460 for a share management system. For example, the interfaces can be implemented by share management system 110 of FIGS. 1-3. In this particular example, interfaces 400, 430, and 460 are example interfaces for corporate entities 140, and represent functions available to corporate entities 140 partnering with share management system 110.

FIG. 4A illustrates an example user interface 400 that displays a dashboard for corporate entity user 140 within share management system 110. Interface 400 includes an interface element 402 that shows the total allocations of shares that corporate entity 140 has issued to share management system 110 for issuing to users of share management system 110. Interface element 404 shows the total number of transactions and allows corporate entity user 140 to select “View details” to review a list of transactions as illustrated in FIG. 4B. Interface element 406 shows the total number of customers and allows corporate entity user 140 to select “View details” to review a list of customers and customer information. Interface element 408 shows the conversion rate of reward points to shares as currently specified by corporate entity 140. Interface element 408 allows corporate entity user 140 to select “Edit” to view or make updates to the conversion rate.

FIG. 4B illustrates an example user interface 430 that displays a list of transactions for corporate entity user 140. Interface element 432 illustrates characteristics of transactions performed and can be used to sort or filter the transactions. Interface element 434 illustrates a list of transactions, sorted by their respective “Created at” timestamps.

FIG. 4C illustrates an example user interface 460 that displays a list of vouchers generated for corporate entity user 140. Interface element 462 illustrates characteristics of vouchers that have been generated and can be used to sort or filter the vouchers. Interface element 464 illustrates a list of vouchers, sorted by their respective “Created at” timestamps.

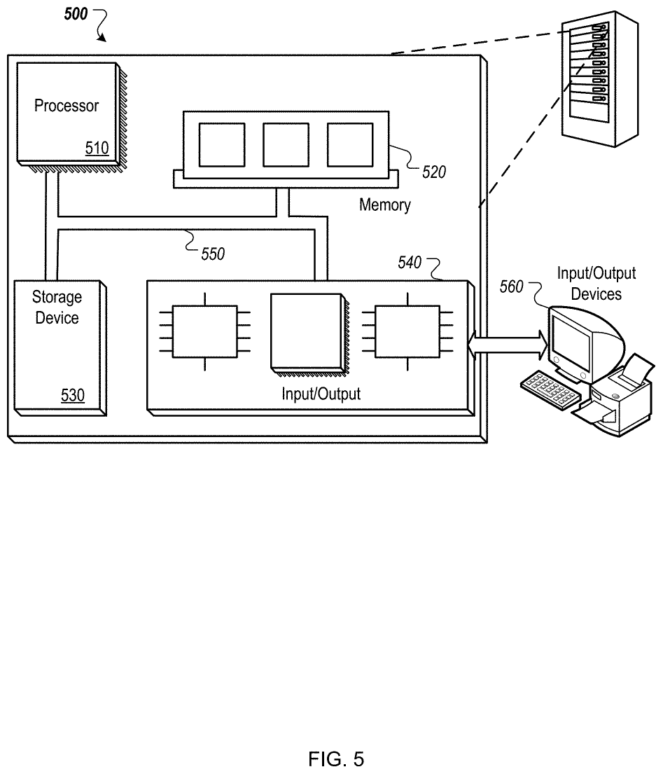

FIG. 5 is block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus.

Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including, by way of example, a programmable processor, a computer, a system on a chip, or multiple ones, or combinations, of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special-purpose logic circuitry, e.g., an FPGA (field-programmable gate array) or an ASIC (application-specific integrated circuit).

Processors suitable for the execution of a computer program include, by way of example, both general and special-purpose microprocessors. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

A method comprising:
obtaining, by one or more processors, an allocation of shares in a privately held company that is not listed on a public stock exchange;
transforming, by the one or more processors, at least a portion of the allocated shares into fractional shares that represent only a portion of ownership provided by a single full share of the privately held company;
detecting, by one or more processors, a trigger event corresponding to a user interaction with a particular entity through a platform of the particular entity separate from the one or more processors, wherein the trigger event triggers allocation of shares in the particular entity by the one or more processors to a user device of a user;
determining, by the one or more processors and based on the detected trigger event, an amount of the fractional shares of the privately held company to be issued to the user device;
generating, by the one or more processors and based on a number of reward points and the amount of shares, a voucher that authorizes allocation of the amount of fractional shares;
transmitting, by the one or more processors and to the user device, the voucher; and
allocating, in response to receiving a payload specifying (i) a voucher identifier matching the voucher and (ii) an entity identifier matching the particular entity from the user device of the user, the amount of fractional shares in the privately held company to the user device.

2. The method of claim 1, wherein: detecting the trigger event comprises receiving data indicating that the user selected at least one of a number of points issued by the particular entity to be received from the user and the amount of shares of the particular entity.

3. The method of claim 1, wherein: detecting the trigger event comprises receiving data indicating that the user performed a particular user interaction other than a financial transaction.

4. The method of claim 1, wherein the trigger event is participation in a program specified by the privately held company.

5. The method of claim 1, wherein transmitting, by the one or more processors and to the user device, the voucher comprises:
transmitting, to a deep link system, the voucher;
receiving, from the deep link system, a deep link that includes a payload that specifies the voucher identifier and the entity identifier; and
transmitting the deep link to the user device.

6. The method of claim 1, further comprising:
determining that the privately held company has mapped the particular user interaction to a particular fractional share factor; and
determining a performance level corresponding to an amount of the particular user interaction performed by the user, wherein determining a fractional number of shares of the particular entity to obtain through a market transaction on behalf of the user comprises determining the fractional number of shares based on a mathematical operation applied to the fractional share factor and the performance level.

7. The method of claim 1, further comprising:
updating, in response to allocating the amount of shares in the particular entity to the user and by the one or more processors, a record of the voucher; and
providing, by the one or more processors, data specifying (i) a debit for the amount of shares against a pool of available shares of the particular entity and (ii) a credit for the amount of shares to the user.

8. A system comprising a memory device and one or more hardware processors configured to perform operations comprising:
obtaining, by one or more processors, an allocation of shares in a privately held company that is not listed on a public stock exchange;
transforming, by the one or more processors, at least a portion of the allocated shares into fractional shares that represent only a portion of ownership provided by a single full share of the privately held company;
detecting, by one or more processors, a trigger event corresponding to a user interaction with a particular entity through a platform of the particular entity separate from the one or more processors, wherein the trigger event triggers allocation of shares in the particular entity by the one or more processors to a user device of a user;
determining, by the one or more processors and based on the detected trigger event, an amount of the fractional shares of the privately held company to be issued to the user device;
generating, by the one or more processors and based on a number of reward points and the amount of shares, a voucher that authorizes allocation of the amount of fractional shares;
transmitting, by the one or more processors and to the user device, the voucher; and
allocating, in response to receiving a payload specifying (i) a voucher identifier matching the voucher and (ii) an entity identifier matching the particular entity from the user device of the user, the amount of fractional shares in the privately held company to the user device.

9. The system of claim 8, wherein: detecting the trigger event comprises receiving data indicating that the user selected at least one of a number of points issued by the particular entity to be received from the user and the amount of shares of the particular entity.

10. The system of claim 8, wherein: detecting the trigger event comprises receiving data indicating that the user performed a particular user interaction other than a financial transaction.

11. The system of claim 8, wherein the trigger event is participation in a program specified by the privately held company.

12. The system of claim 8, wherein transmitting, by the one or more processors and to the user device, the voucher comprises:
transmitting, to a deep link system, the voucher;
receiving, from the deep link system, a deep link that includes a payload that specifies the voucher identifier and the entity identifier; and
transmitting the deep link to the user device.

13. The system of claim 8, further comprising:
determining that the privately held company has mapped the particular user interaction to a particular fractional share factor; and
determining a performance level corresponding to an amount of the particular user interaction performed by the user, wherein determining a fractional number of shares of the particular entity to obtain through a market transaction on behalf of the user comprises determining the fractional number of shares based on a mathematical operation applied to the fractional share factor and the performance level.

14. The system of claim 8, further comprising:
updating, in response to allocating the amount of shares in the particular entity to the user and by the one or more processors, a record of the voucher; and
providing, by the one or more processors, data specifying (i) a debit for the amount of shares against a pool of available shares of the particular entity and (ii) a credit for the amount of shares to the user.

15. A non-transitory computer readable medium storing executable instructions that, upon execution by one or more processors, cause the one or more processors to perform operations comprising:
obtaining, by one or more processors, an allocation of shares in a privately held company that is not listed on a public stock exchange;
transforming, by the one or more processors, at least a portion of the allocated shares into fractional shares that represent only a portion of ownership provided by a single full share of the privately held company;
detecting, by one or more processors, a trigger event corresponding to a user interaction with a particular entity through a platform of the particular entity separate from the one or more processors, wherein the trigger event triggers allocation of shares in the particular entity by the one or more processors to a user device of a user;
determining, by the one or more processors and based on the detected trigger event, an amount of the fractional shares of the privately held company to be issued to the user device;
generating, by the one or more processors and based on a number of reward points and the amount of shares, a voucher that authorizes allocation of the amount of fractional shares;
transmitting, by the one or more processors and to the user device, the voucher; and
allocating, in response to receiving a payload specifying (i) a voucher identifier matching the voucher and (ii) an entity identifier matching the particular entity from the user device of the user, the amount of fractional shares in the privately held company to the user device.

16. The non-transitory computer readable medium of claim 15, wherein detecting the trigger event comprises receiving data indicating that the user selected at least one of a number of points issued by the particular entity to be received from the user and the amount of shares of the particular entity.

17. The non-transitory computer readable medium of claim 15, wherein detecting the trigger event comprises receiving data indicating that the user performed a particular user interaction other than a financial transaction.

18. The non-transitory computer readable medium of claim 15, wherein transmitting, by the one or more processors and to the user device, the voucher comprises:
transmitting, to a deep link system, the voucher;
receiving, from the deep link system, a deep link that includes a payload that specifies the voucher identifier and the entity identifier; and
transmitting the deep link to the user device.

19. The non-transitory computer readable medium of claim 15, wherein the instructions cause the one or more processors to perform operations further comprising:
determining that the privately held company has mapped the particular user interaction to a particular fractional share factor; and
determining a performance level corresponding to an amount of the particular user interaction performed by the user, wherein determining a fractional number of shares of the particular entity to obtain through a market transaction on behalf of the user comprises determining the fractional number of shares based on a mathematical operation applied to the fractional share factor and the performance level.

20. The non-transitory computer readable medium of claim 15, wherein the instructions cause the one or more processors to perform operations further comprising:
updating, in response to allocating the amount of shares in the particular entity to the user and by the one or more processors, a record of the voucher; and
providing, by the one or more processors, data specifying (i) a debit for the amount of shares against a pool of available shares of the particular entity and (ii) a credit for the amount of shares to the user.
